(19) United States
(12) Patent Application Publication
(10) Pub. No.: US 2024/0025159 A1
(43) Pub. Date: Jan. 25, 2024

(54) ANTIWEAR FILM FOR DECORATIVE PANEL

(71) Applicant: AKZENTA PANEELE + PROFILE GMBH, Kaisersesch (DE)

(72) Inventor: Felix HÜLLENKREMER, Koblenz (DE)

(21) Appl. No.: 18/026,798

(22) PCT Filed: Sep. 24, 2021
(86) PCT No.: PCT/EP2021/076381

§ 371 Date: Mar. 16, 2023

(30) Foreign Application Priority Data
Sep. 24, 2020 (EP) 20198094.3

(51) Int. Cl. B32B 27/08; B32B 7/12; B32B 27/28; B32B 27/30; B32B 37/12; B32B 27/32

(52) U.S. Cl. CPC B32B 27/08; B32B 7/12; B32B 27/283; B32B 27/308; B32B 37/1207; B32B 27/32; B32B 2451/00; B32B 2307/554; B32B 2307/558; B32B 2037/1215; B32B 2037/1253

(57) ABSTRACT

The present disclosure relates to an antiwear film, which comprises a thermoplastic carrier film and an antiwear layer on the thermoplastic carrier film; wherein there is an adhesion promoter layer, at least in some parts, between the thermoplastic carrier film and the antiwear layer; wherein the thermoplastic carrier film has a thermoplastic material; wherein the adhesion promoter layer has an adhesion promoter; and wherein the antiwear layer has a mixture having a polymethyl methacrylate and polyorganosiloxane. The disclosure also relates to a decorative panel, which comprises a carrier plate, at least one decorative layer, at least one laminating adhesive layer and an antiwear film according to the disclosure, wherein the antiwear film is arranged with its carrier film facing the carrier plate, and wherein the decorative layer and the laminating adhesive layer are located between the carrier plate and the thermoplastic carrier film. The disclosure additionally relates to a method for producing the antiwear film and for producing the decorative panel.

### CROSS-REFERENCE TO RELATED APPLICATIONS

This application is a U.S. National Phase Application under 35 U.S.C. 371 of International Application No. PCT/EP2021/076381, filed on Sep. 24, 2021, which claims the benefit of European Patent Application No. 20198094.3, filed on Sep. 24, 2020. The entire disclosure of the above European Patent Application is incorporated herein by reference.

### FIELD

The present disclosure relates to antiwear films and a method for producing antiwear films, as well as decorative panels comprising an antiwear film and a method for producing decorative panels comprising an antiwear film.

### BACKGROUND

This section provides background information related to the present disclosure which is not necessarily prior art.

Decorative panels comprising an antiwear layer are known per se and are used in particular as panels for decorative cladding of floors, walls, ceilings or doors. In the sense of the disclosure, the term decorative panel is understood to mean wall, ceiling, door or floor panels which have a decoration applied to a carrier plate. Decorative panels are used in a variety of ways, both in the field of interior design of rooms and for the decorative cladding of buildings, for example in exhibition stand construction. One of the most common fields of application of decorative panels is their use as floor covering and for covering ceilings, walls or doors. In many cases, the decorative panels comprise a decoration and a surface structuring that is intended to imitate a natural material.

For protecting the applied decorative layer, wear protection or cover layers are usually applied above the decorative layer. In many cases, it is provided that a surface structuring imitating a decorative template is incorporated into such wear protection or cover layers, so that the surface of the decorative panel has a haptically perceptible structure, the shape and pattern of which are adapted to the decoration applied, in order to achieve a reproduction of a natural material as faithful as possible even with respect to the haptic.

As antiwear layers for decorative panels, in particular layers made of thermosetting plastics, such as melamine resins, have established. A disadvantage of such antiwear layers can be that they impair the recyclability of decorative panels, especially when applied thereon. Furthermore, layers of thermosetting plastics can only be produced with difficulty as semi-finished products, which results in limitations in process control during the manufacture of decorative panels with antiwear layers.

Antiwear layers for decorative panels and their production can therefore still offer potential for improvement.

### SUMMARY

This section provides a general summary of the disclosure, and is not a comprehensive disclosure of its full scope or all of its features.

It is therefore the object of the present disclosure to provide improved antiwear layers which allow a more flexible process control in the production of decorative panels with wear protection and improved recyclability of such panels.

The disclosure proposes an antiwear film. The antiwear film comprises a thermoplastic carrier film and an antiwear layer arranged on the thermoplastic carrier film, wherein between the thermoplastic carrier film and the antiwear layer an adhesion promoter layer is arranged partially, wherein said thermoplastic carrier film comprises a thermoplastic resin, said adhesion promoter layer comprises an adhesion promoter, and said antiwear layer comprises a mixture including a polymethyl methacrylate and polyorganosiloxane.

Surprisingly, it has been shown that good wear protection properties of decorative panels can be achieved by the antiwear film described above. Compared to known antiwear layers, the antiwear film according to the disclosure can be advantageously produced as a semi-finished product, which results in a more flexible process control during the production of decorative panels. In addition, it has been surprisingly found, that the antiwear film has an improved recyclability in combination with decorative panels. At the same time, no impairments are apparent with regard to the appearance of decorative panels provided with the antiwear film according to the disclosure.

In the sense of the disclosure, the term “antiwear film” is to be understood as a film which can be applied to decorative panels or other materials and which protects against wear, in particular against physical impact. Accordingly, the term “antiwear layer” is to be understood in the sense of the disclosure as a layer which protects against wear.

In the sense of the present disclosure, the term “thermoplastic resins” is understood to mean plastics, each of which can be plastically deformed within a certain temperature range. For example, polyvinyl chloride, polyolefins, such as polyethylene (PE) or polypropylene (PP), polyamides (PA), polyurethanes (PU), polystyrene (PS), acrylonitrile butadiene styrene (ABS), polymethyl methacrylate (PMMA), polycarbonate (PC), polyethylene terephthalate (PET), polyether ether ketone (PEEK) or mixtures or copolymers thereof can be thermoplastic resins.

In the sense of the present disclosure, an “adhesion promoter” is understood to mean a substance suitable for producing a better bond between two materials, in particular the adhesion between the carrier film and the antiwear layer.

Accordingly, an antiwear film as described above can in particular enable a better recyclability of decorative panels provided therewith and a more flexible process control during their manufacture.

In detail, the antiwear film according to the disclosure comprises a thermoplastic carrier film. The carrier film comprises a thermoplastic resin. The carrier film thus advantageously serves as a carrier for further layers of the antiwear film and can, in particular, prevent these from tearing unintentionally. The carrier film can also serve as a bonding layer in a subsequent production of a decorative panel. In addition, the carrier film can allow easy handling of the antiwear film. For example, the antiwear film may be coilable by means of the carrier film, which may allow for easy storage of the antiwear film. The thermoplastic properties of the carrier film can also prevent stresses in a decorative panel comprising an antiwear film according to the disclosure, since the thermoplastic carrier film can at least partially adapt to unevenness or tensile stresses during manufacture.

According to the disclosure, an antiwear layer is arranged on the thermoplastic carrier film. The antiwear layer comprises a mixture comprising a polymethyl methacrylate and a polyorganosiloxane. Surprisingly, it could be shown that good wear protection properties can be achieved by the mixture comprising polymethyl methacrylate and polyorganosiloxane. Without being bound to theory, it is assumed that the polyorganosiloxane in the antiwear layer migrates to the surface of the antiwear film, where it forms an area with high scratch resistance that cannot be wiped off.

The antiwear film moreover comprises an adhesion promoter layer, wherein the adhesion promoter layer includes an adhesion promoter. Surprisingly, it could be shown that such an adhesion promoter layer does not impair the wear protection properties of the antiwear layer and, at the same time, the adhesion between the antiwear layer and the thermoplastic carrier film is improved. In this way, it is possible to ensure that the antiwear layer is not unintentionally detached from the thermoplastic carrier film when stressed, which would severely impair the wear protection properties. In particular, it can be achieved that the antiwear layer does not detach from the thermoplastic carrier film, for example, when the antiwear film is coiled up and stored for a long time or during further processing of the antiwear film.

Surprisingly, it could also be shown that the antiwear film can be easily recycled as a whole without the need for mechanical separation of the individual layers. Thus, the interaction of the various layers as a whole results in the advantageous properties of the antiwear film according to the disclosure.

Preferably, it can be provided that the thermoplastic carrier film comprises greater than or equal to 75 wt.-%, more preferably greater than or equal to 90 wt.-%, further preferably greater than or equal to 95 wt.-%, particularly preferably greater than or equal to 99 wt.-%, based on the thermoplastic carrier film of the thermoplastic resin.

This means that the thermoplastic carrier film may also comprise other substances in addition to the thermoplastic resin, but consists essentially of the thermoplastic resin. For example, the thermoplastic carrier film may include additives which, for example, affect the color, the impact strength or the flammability of the carrier film. It has been shown that in the indicated ranges, the advantageous recycling properties and carrier properties of the thermoplastic carrier film are particularly well pronounced. In particular, however, the use of the structure according to the disclosure results in a decorative panel which is particularly advantageously recyclable as a whole.

Preferably, it can be provided that the adhesion promoter layer comprises greater than or equal to 75 wt.-%, more preferably greater than or equal to 90 wt.-%, further preferably greater than or equal to 95 wt.-%, particularly preferably greater than or equal to 99 wt.-%, based on the adhesion promoter layer of the adhesion promoter.

This is understood to mean that the adhesion promoter layer consists essentially of adhesion promoter, but may also comprise other substances. For example, it may be provided that the adhesion promoter is diluted with or dispersed in a plastic. In this way, it can be achieved, for example, that the adhesion promoter is readily processable during the production of the antiwear film and can be applied simply and thin onto the thermoplastic carrier film. In the aforementioned ranges, the advantages achieved by the adhesion promoter layer are particularly pronounced.

Preferably, it can be provided that the antiwear layer comprises greater than or equal to 75 wt.-%, more preferably greater than or equal to 90 wt.-%, further preferably greater than or equal to 95 wt.-%, particularly preferably greater than or equal to 99 wt.-%, based on the antiwear layer of the mixture comprising polymethyl methacrylate and polyorganosiloxane.

This means that the antiwear layer in addition to polymethyl methacrylate and polyorganosiloxane may comprise other substances, but essentially consists of polymethyl methacrylate and polyorganosiloxane. It could be shown that in the range other substances can be added to the antiwear layer which, for example, advantageously change the impact strength, the flammability or the optical properties of the antiwear layer. In the aforementioned ranges the antiwear layer exhibits particularly good wear protection properties.

Preferably, it may be provided that the thermoplastic resin is selected from the group consisting of polypropylene, polyvinyl chloride, polyethylene, copolymers thereof and mixtures thereof, wherein the thermoplastic resin is in particular polypropylene. According to a further preferred embodiment of the disclosure, the polypropylene has a melt flow Index (MFI) in a range between greater than or equal to 2 g/10 min and less than or equal to 20 g/10 min, in particular between greater than or equal to 5 g/10 min and less than or equal to 19 g/10 min. Here, the melt flow index can be determined in accordance with ISO 1133. According to a further preferred embodiment, the polypropylene is a nucleated homopolymer with high transparency or a randomized copolymer with high transparency.

By use of the aforementioned thermoplastic resins, it can be achieved that the antiwear film is particularly well recyclable. In addition, it can be achieved that the antiwear film is particularly stable. Surprisingly, it has been shown that the aforementioned thermoplastic resins are adapted to make the thermoplastic carrier film particularly thin without impairing the mechanical properties of the antiwear film too much. Without being bound by theory, it is assumed that these thermoplastic resins, and in particular polypropylene, are particularly compatible with the composition of the antiwear layer.

Preferably, it may be provided that the adhesion promoter is a polyolefin copolymer, preferably a polyolefin graft copolymer, more preferably a polypropylene graft copolymer, in particular a maleic anhydride modified polypropylene graft copolymer, an acrylic acid modified polypropylene or polyethylene, a maleic anhydride modified polyethylene, a metallocene catalyzed linear low density polyethylene (metallocene LLDPE), a metallocene catalyzed linear high density polyethylene (metallocene HDPE), or an ethylene-vinyl acetate copolymer.

This allows to achieve particularly strong adhesion between the antiwear layer and the thermoplastic carrier film. Surprisingly, it could be shown that in particular maleic anhydride-modified polypropylene graft copolymer is particularly suitable for improving the adhesion, even if the antiwear layer includes a high proportion of polyorganosiloxane.

Preferably, it may be provided that the maleic anhydride-modified polypropylene graft copolymer has a maleic acid content in a range from greater than or equal to 0.1 wt.-% to less than or equal to 5 wt.-%, preferably from greater than or equal to 0.5 wt.-% to less than or equal to 1.5 wt.-%, based on the maleic anhydride-modified polypropylene graft copolymer.

In the ranges indicated, a particularly strong and durable adhesion between the thermoplastic carrier film and the antiwear film can be achieved in an advantageous manner.

Preferably, it can be provided that the polymethyl methacrylate comprises an impact strength modifier, in particular in an amount in a range of greater than or equal to 0.1 wt.-% to less than or equal to 5 wt.-%, preferably from greater than or equal to 0.5 wt.-% to less than or equal to 1.5 wt.-%, based on the polymethyl methacrylate. According to a further preferred embodiment, the impact strength modifier is at least one compound selected from the group consisting of thermoplastic elastomers, ethylene glycol dimethacrylate, ethylene butyl acrylate, ethylene-methyl acrylate copolymer and polybutyl acrylate.

Surprisingly, it could be shown that in this way the impact strength of the antiwear layer could be improved without deteriorating the wear properties, such as the scratch resistance.

Preferably, it may be provided that the polyorganosiloxane is a polydimethylsiloxane.

Polydimethylsiloxane can be dissolved particularly well in polymethyl methacrylate compared to other polyorganosiloxanes. As a result, a particularly stable antiwear layer can be achieved. Furthermore, polydimethylsiloxane advantageously has a particularly little adverse effect on the optical properties of the antiwear layer.

Preferably, it may be provided that the polyorganosiloxane has a number average molecular weight in a range from greater than or equal to 50 kDa to less than or equal to 700 kDa, preferably from greater than or equal to 100 kDa to less than or equal to 500 kDa, further preferably greater than or equal to 150 kDa to less than or equal to 300 kDa.

In the sense of the present disclosure, “number average molecular weight” means the average value of the molecular weight of the corresponding polymer, wherein it has been averaged over the relative number of polymers of corresponding molecular weight. In other words, the number average molecular weight indicates the expected molar mass of a polymer molecule taken at random from the sample.

It has been shown that polyorganosiloxanes with the indicated molecular weight are particularly suitable for producing an antiwear layer with particularly good antiwear properties.

It may be particularly preferred that the polyorganosiloxane is polydimethylsiloxane with a number average molecular weight in a range from greater than or equal to 100 kDa to less than or equal to 300 kDa.

In this way, particularly advantageous wear properties can be achieved and, at the same time, a particularly high transparency of the antiwear layer can be maintained.

Preferably it may be provided that the mixture comprising polymethyl methacrylate and polyorganosiloxane comprises polymethyl methacrylate in a range of greater than or equal to 90 wt.-% to less than 100 wt.-%, preferably greater than or equal to 95 wt.-% to less than or equal to 99.9 wt.-%, further preferably greater than or equal to 98 wt.-% to less than or equal to 99.5 wt.-%, particularly preferably greater than or equal to 98.5 wt.-% to less than or equal to 99 wt.-%, based on the mixture, wherein the mixture comprising polymethyl methacrylate and polyorganosiloxane comprises polyorganosiloxane in a range from greater than 0 wt.-% to less than or equal to 10 wt.-%, preferably greater than or equal to 0.1 wt.-% to less than or equal to 5 wt.-%, further preferably greater than or equal to 0.5 wt.-% to less than or equal to 2 wt.-%, particularly preferably greater than or equal to 1 wt.-% to less than or equal to 1.5 wt.-%, based on the mixture.

In the ranges indicated, good wear properties can be advantageously achieved and, at the same time, a good processability of the antiwear layer and a good adhesion to the thermoplastic carrier film can be maintained.

Preferably, it may be provided that the thermoplastic carrier film has a thickness in a range from greater than or equal to 0.1 mm to less than or equal to 1 mm, preferably from greater than or equal to 0.2 mm to less than or equal to 0.8 mm, further preferably from greater than or equal to 0.3 mm to less than or equal to 0.6 mm.

In this way, it can be achieved that the carrier film has a particularly good stability. In this way it can particular be achieved that the thermoplastic carrier film tears only poorly during further processing or when coiled up for storage. In addition, it can be achieved in this way that the carrier film has a sufficient thickness to compensate for stresses between the panel and the antiwear layer when used in a decorative panel.

Preferably, it may be provided that the adhesion promoter layer has a thickness in a range from greater than or equal to 1 μm to less than or equal to 0.1 mm.

In this way, a particularly good adhesion can be achieved

Preferably, it can be provided that the antiwear layer has a thickness in a range from greater than or equal to 0.01 mm to less than or equal to 1 mm, preferably from greater than or equal to 0.1 mm to less than or equal to 0.8 mm, further preferably from greater than or equal to 0.4 mm to less than or equal to 0.6 mm. In particular, it may be advantageously provided that the thickness of the antiwear layer is greater than or equal to 5% to less than or equal to 30% of the total thickness of the film structure according to the disclosure consisting of an antiwear layer, an adhesion promoter layer and a carrier film.

In this way, it can be achieved that the polyorganosiloxane forms a layer with a particularly advantageous thickness at the surface of the antiwear film. Thus, a particularly good and, in particular, durable wear protection can be achieved.

Preferably, it can be provided that the antiwear film has a web-like shape.

In the sense of the present disclosure, a “web-like shape” can be understood to mean a shape which has a significantly greater width compared to its thickness and a significantly greater length compared to its width, for example greater than 15 meters.

In this way the antiwear film can be used particularly well for the production of decorative panels. In particular, the antiwear film can thus be easily coiled up and stored on reels and used at a later time for the production of decorative panels. In addition, a web-like shape can be produced continuously. Accordingly, an antiwear film with a web-like shape can be produced correspondingly simultaneously with other components of a decorative panel and can easily be continuously brought together with these components, for example, via rolls.

Preferably, it can be provided that the antiwear layer at least partially has a surface structuring.

Advantageously, in this way a pleasant haptic impression of the surface of the antiwear film can be provided.

Preferably, it can be provided that the surface structuring is adapted in order to obtain a replica of a natural material as faithful to the original as possible in terms of the haptics.

Preferably, it can be provided that the antiwear layer comprises a lacquer-containing top layer arranged on the surface of the antiwear film, wherein the lacquer-containing top layer preferably comprises a topcoat selected from the group consisting of melamine resin and acrylate-based plastic compositions, in particular polyurethane-modified acrylate plastic compositions.

In this way it can advantageously be achieved that the wear protection properties can be further improved. Compared to antiwear layers that only have a lacquer-containing top layer and do not have an antiwear layer comprising polymethyl methacrylate and polyorganosiloxane, such a further improvement of the wear protection wear protection properties can even be achieved with a particularly thin lacquer-containing top layer, wherein the recyclability is deteriorated only to very little extent.

The disclosure also proposes a decorative panel. The decorative panel comprises a carrier plate, at least one decorative layer, at least one laminating adhesive layer and an antiwear film according to the disclosure, wherein the antiwear film is aligned at the carrier film side with respect to the carrier plate, and wherein the decorative layer and the laminating adhesive layer are arranged between the carrier plate and the thermoplastic carrier film.

According to an alternative embodiment, it may be provided that the antiwear film according to the disclosure is thermally laminated onto a carrier plate comprising a decorative layer. In this respect, in an alternative embodiment, a decorative panel is proposed which comprises a carrier plate, at least one decorative layer and an antiwear film according to the disclosure, wherein the antiwear film is aligned at the carrier film side with respect to the carrier plate and wherein the decorative layer is arranged between the carrier plate and the thermoplastic carrier film. For the production of such a decorative panel, it can be provided, for example, that the carrier plate provided with the decorative layer is preheated to a temperature of about 100° C. and an antiwear film according to the disclosure is applied to the preheated carrier plate at a lamination temperature between greater than or equal to 140° C. to less than or equal to 160° C., preferably between greater than or equal to 150° C. to less than or equal to 160° C.

Surprisingly, it could be shown that such decorative panels have good wear properties compared to other decorative panels, while they can be produced easier and more flexible. In addition, such decorative panels can be better recycled, since in particular the use of melamine resins and lacquers, such as acrylate, polyurethane or epoxy lacquers, can be dispensed with.

“Carrier film side” means that the antiwear film is aligned with the side with respect to the carrier plate where the carrier film is disposed. Thus, the decorative panel comprises a layered composite comprising the carrier plate, the thermoplastic carrier film arranged on the carrier plate and the antiwear layer arranged on the carrier film, wherein the adhesion promoter layer is arranged between the antiwear layer and the thermoplastic carrier film, and the decorative layer and the optional laminating adhesive layer are arranged between the carrier plate and the thermoplastic carrier film.

In the sense of the present disclosure, the term “decorative panel” means wall, ceiling, door or floor panels, which have a decoration applied to a carrier plate. Here, decorative panels are used in a variety of ways both in the field of interior design of rooms and for decorative cladding of buildings, for example in exhibition stand construction. One of the most common fields of application of decorative panels is their use as floor covering and for covering ceilings, walls or doors. In many cases, the decorative panels comprise a decoration and a surface structuring intended to imitate a natural material.

In the sense of the present disclosure, a “carrier plate” is understood to mean a layer serving as a core or a base layer in a finished panel, which layer may in particular comprise a natural material, such as a wood-based material, a fiber material or a material comprising a plastic. For example, the carrier plate may provide or con-tribute to a suitable stability for a panel.

In this context, wood-based materials in the sense of the disclosure are, in addition to solid wood materials, materials such as cross-laminated timber, glue-laminated timber, blockboard, veneered plywood, laminated veneer lumber, parallel strand lumber and bending plywood. In addition, wood-based materials in the sense of the disclosure are also chipboards such as pressboards, extruded boards, oriented structural boards (OSB) and laminated strand lumber as well as wood fiber materials such as wood fiber insulation boards (HFD), medium hard and hard fiberboards (MB, HFH) and in particular medium density fiberboards (MDF) and high density fiberboards (HDF). Even modern wood-based materials such as wood polymer materials (wood plastic composite, WPC), sandwich boards made of a lightweight core material such as foam, rigid foam or honeycomb paper and a layer of wood applied thereto, and minerally bonded, for example with cement, chipboards are wood-based materials in the sense of the disclosure. Moreover, cork represents a wood-based material in the sense of the disclosure.

Plastic materials which can be used in the manufacture of corresponding panels or the carrier plates are, for example, thermoplastic resins such as polyvinyl chloride, polyolefins (for example polyethylene (PE), polypropylene (PP)), polyamides (PA), polyurethanes (PU), polystyrene (PS), acrylonitrile butadiene styrene (ABS), polymethyl methacrylate (PMMA), polycarbonate (PC), polyethylene terephthalate (PET), polyetheretherketone (PEEK), or blends or co-polymers thereof. The plastic materials may contain common fillers, for example calcium carbonate (chalk), aluminum oxide, silica gel, quartz flour, wood flour, gypsum. They can also be colored in a known manner.

In particular, the carrier plate can be a web-like carrier plate or a sheet-like carrier plate. Here, a “web-like carrier plate” can be understood to mean a carrier plate which, for example, in its manufacturing process has a web-like shape and thus has a significantly greater length compared with its thickness or width and whose length may be, for example, greater than 15 meters.

In the sense of the present disclosure the term “sheet-like carrier plate” can be understood to mean a carrier plate which is formed by separating the web-like carrier plate and is formed in the shape of a plate. Furthermore, the sheet-like carrier plate may already predetermine the shape and/or size of a decorative panel in the size of commercially available panels. However, the sheet-like carrier plate may also be provided as a large panel. A large panel in the sense of the disclosure is in particular a carrier plate, the dimensions of which exceed the dimensions of the final decorative panels by a multiple and which is divided into a corresponding plurality of decorative panels in the course of the manufacturing process, for example by sawing, laser cutting or water jet cutting. For example, the large panel may correspond to the web-like carrier plate.

In the sense of the present disclosure, a “decorative layer” can be understood to mean a visually perceptible layer which comprises a decoration. In many cases, the decoration may imitate a natural material. Examples of such imitated natural materials are wood species such as maple, oak, birch, cherry, ash, walnut, chest-nut, wenge or exotic woods such as panga-panga, mahogany, bamboo and bubinga. In addition, natural materials such as stone or ceramic surfaces can be replicated.

In the sense of the present disclosure, a “laminating adhesive layer” is understood to mean a layer comprising a laminating adhesive which bonds adjacent layers to one another.

Preferably, it can be provided that the decorative layer is arranged on the carrier plate and/or the thermoplastic carrier film.

This means that the decorative layer contacts the carrier plate or contacts the thermoplastic carrier film or a first decorative layer contacts the carrier plate and a second decorative layer contacts the thermoplastic carrier film.

By arranging the decorative layer on the carrier plate, the decorative panel can be produced particularly easily by known means. Advantageously, it can be achieved that the decoration can be applied particularly precisely, because the carrier plate has a certain stability, which facilitates precise application of the decoration. By applying the decorative layer onto the thermoplastic carrier film, it can be achieved that the decoration can be aligned particularly precisely with a structuring of the antiwear layer. A first decorative layer on the carrier plate and a second decorative layer on the carrier film advantageously allow depth effects to be realized in the decoration.

In other words, it may be provided that the decorative layer contacts the carrier plate and the laminating adhesive layer is disposed on the decorative layer, wherein the thermoplastic carrier film is disposed on the laminating adhesive layer. Alternatively, it can be provided that the laminating adhesive layer contacts the carrier plate and the decorative layer is disposed on the laminating adhesive layer, wherein the thermoplastic carrier film is disposed on the decorative layer. Further alternatively, it may be provided that a first decorative layer contacts the carrier plate and the laminating adhesive layer is disposed on the first decorative layer, wherein a second decorative layer contacting the thermoplastic carrier film is disposed on the laminating adhesive layer.

Preferably, it can be provided that the decorative layer comprises a printing subsurface, a decorative printing and optionally a primer layer.

In this way, it can be achieved that the decoration can be applied particularly precisely and is particularly durable and moreover has a particularly high color fidelity.

Preferably, it can be provided that the laminating adhesive layer comprises a laminating adhesive selected from the group consisting of hot melt adhesive and UV-curable adhesive, in particular acrylic-based UV adhesives.

As a result, the carrier plate and the thermoplastic carrier film exhibit a particularly strong and durable bond.

Preferably, it can be provided that the carrier plate comprises polypropylene, polyethylene, polyvinyl chloride, copolymers thereof and mixtures thereof.

In this way, it can be achieved that the carrier plate is particularly well bonded to the antiwear film and the decorative panel exhibits good overall mechanical properties. Furthermore, it can be achieved in this way that the decorative panel as a whole exhibits particularly good recyclability.

Preferably, it can be provided that the carrier plate comprises a matrix material and a solid material, wherein the matrix material is present in an amount, based on the carrier plate, from ≥20 wt.-% to ≤55 wt.-%, in particular from ≥35 wt.-% to ≤45 wt.-%, and wherein the solid material is present in an amount, based on the carrier plate, from ≥45 wt.-% to ≤80 wt.-%, in particular from ≥55 wt.-% to ≤65 wt.-%, and wherein the matrix material and the solid material are together present in an amount, based on the carrier plate, from ≥95 wt.-%, in particular ≥99 wt.-%.

Depending on the desired field of application and the desired properties of the panel, the proportions of matrix material and solid material, respectively, can be selected. This can enable a good adaptability to the desired field of application. In principle, however, it may be preferred that the proportion of the solid material is greater than or equal to the proportion of the matrix material. It has been shown that a decorative panel according to the disclosure comprising a carrier plate having the composition described above can be recycled particularly well and at the same time has particularly good mechanical properties.

Preferably, it can be provided that at least 50 wt.-%, in particular at least 80 wt.-%, in particular at least 95 wt.-%, based on the solid material, of the solid material is formed from a solid material composition consisting of at least a first layered silicate powder and a second layered silicate powder, and at least 50 wt.-%, in particular at least 80 wt.-%, in particular at least 95 wt.-%, based on the matrix material, of the matrix material is formed by a plastic composition consisting of a homopolymer and at least a first copolymer and a second copolymer.

In this context, a layered silicate powder is understood to mean, in a manner known per se, a powder of a layered silicate. A layered silicate is a known term for minerals from the group of silicates, the silicate anions of which are usually arranged in layers. For example, layered silicates are understood to mean minerals from the mica group, the chlorite group, the kaolinite group and the serpentine group.

Thus, the solid material is advantageously formed at least by a major part from the mineral substance layered silicate, wherein this substance can be used, for example, in powder form or can be present in the carrier plate in the form of particles. In principle, the solid material can consist of a powdery solid.

Layered silicates offer the advantage that they can allow the production of a carrier with good mechanical properties and at the same time can be easily processed into corresponding powders due to their layer structure.

Preferably, it can be provided that the solid composition comprises the first layered silicate powder from ≥35 wt.-% to ≤85 wt.-%, preferably ≥50 wt.-% to ≤70 wt.-%, based on the solid composition, in the form of particles having a particle size D₅₀ in a range from ≥3 μm to ≤6 μm, and/or having a particle size D₉₈ in a range of 10 μm to 30 μm, and the second layered silicate powder from ≥15 wt.-% to ≤65 wt.-%, preferably ≥30 wt.-% to ≤50 wt.-%, based on the solid composition, in the form of particles having a particle size D₅₀ in a range from 6 μm to 10 μm, and/or which have a particle size D₉₈ in a range from ≥20 μm to ≤40 μm.

Particularly when using layered silicate powder with particles, the carrier plate or the decorative panel exhibits particularly preferred mechanical properties. For the determination of the particle size distribution, recourse can be made to the generally known methods, such as laser diffractometry, by means of which particle sizes in the range from a few nanometers to several millimeters can be determined. By means of this method, it is also possible to determine D₅₀ or D₉₈ values which respectively indicate that 50% (D₅₀) or 98% (D₉₈) of the measured particles are smaller than the respective specified value. The same applies to the determination of the grain size or the mean grain size. These values, too, can preferably be determined by means of laser diffractometry.

In the case of a discrepancy between the measured values obtained by different measuring methods, the value determined by means of laser diffractometry is considered by the applicant to be representative.

Furthermore, it may be advantageous if the first layered silicate powder is present at a bulk density according to DIN 53468 in a range from ≥2.4 g/cm³ to ≤3.6 g/cm³, such as in a range from ≥2.9 g/cm³ to ≤3.1 g/cm³. Furthermore, it may be advantageous if the second layered silicate powder is present at a bulk density according to DIN 53468 in a range from ≥3.4 g/cm³ to ≤4.6 g/cm³, such as in a range from ≥3.9 g/cm³ to ≤4.1 g/cm³. In particular it may be provided that the first layered silicate powder is present at a bulk density according to DIN 53468 which is less than or equal to the bulk density at which the second layered silicate powder is present.

According to one embodiment of the disclosure, it may be provided that the homopolymer, the first copolymer and/or the second copolymer consists at least partially of recycled material. Here, according to a further embodiment of the disclosure, the proportion of recycled material per polymer or copolymer type can be in a range from ≥2 wt.-% to ≤100 wt.-%, preferably ≥5 wt.-% to ≤90 wt.-%, in particular ≥10 wt.-% to ≤80 wt.-%, such as ≥15 wt.-% to ≤70 wt.-%. It may further be provided that the proportion of recycled material is different for each polymer or copolymer type. In particular, it may be provided that at least one polymer or copolymer type has a proportion of recycled material of ≤90 wt.-%, while the other polymer or copolymer types independently from each other have a proportion of recycled material of ≥50 wt.-%, in particular ≥10 wt.-%.

The fact that the matrix material comprises, in particular, a plastic, such as a thermoplastic resin, results in that the decorative panel, despite the high stability, is very elastic or resilient and/or soft to bend, which enables a comfortable impression when walking on it and can also reduce the noise that occurs when walking on it compared to conventional materials, and thus an improved impact sound can be realized.

Preferably, it may be provided that the homopolymer, the first copolymer and the second copolymer comprise polypropylene. Polypropylene is particularly suitable as a matrix material because, on the one hand, it is available at low cost and, on the other hand, as a thermoplastic resin has good properties as a matrix material for embedding the solid material.

In particular, in this way it is also enabled that the decorative panel can be recycled particularly well.

Preferably, it can be provided that the first copolymer comprises a heterophasic polypropylene and the second copolymer comprises an ethylene-propylene copolymer and an isotactic polypropylene.

In this way, it can also be achieved in particular that the decorative panel is particularly well recyclable.

Further preferably, it may be provided that the second copolymer has an ethylene content from ≥8 wt.-% to ≤22 wt.-%, preferably from ≥13 wt.-% to ≤17 wt.-%.

Preferably, it may be provided that the melt flow rate of the homopolymer is greater than the melt flow rate of the first copolymer and the second copolymer.

Preferably, it may be provided that the melt flow rate of the second copolymer is greater than the melt flow rate of the first copolymer.

Preferably, it may be provided that the homopolymer is present in a proportion of ≥10 wt.-% to ≤40 wt.-%, based on the plastic composition, and/or that the first copolymer is present in a proportion of ≥40 wt.-% to ≤70 wt.-%, based on the plastic composition, and/or that the second copolymer is present in a proportion of ≥10 wt.-% to ≤40 wt.-%, based on the plastic composition.

Preferably, it may be provided that the solid material comprises at least one further solid material in addition to the solid composition.

It may preferably be provided that the further solid material has a bulk density in a range of ≤2000 kg/m³, in particular of ≤1500 kg/m³, for example of ≤1000 kg/m³, particularly preferably of ≤500 kg/m³ and/or that the further solid material is selected from the group consisting of wood, expanded clay, volcanic ash, pumice, aerated concrete, inorganic foams and cellulose.

It has been shown that decorative panels according to the disclosure having the above-described features individually and in combination each have particularly good mechanical properties. Furthermore, it could be shown that they can be recycled particularly well with the antiwear film and that the antiwear film is particularly well bonded to the corresponding carrier plate.

Further preferably, it can be provided that the antiwear layer at least partially has a surface structuring and the surface structuring is at least partially synchronous with a decoration of the decorative layer.

This allows the decorative panel to imitate a template material particularly well.

The disclosure further proposes a method of producing the antiwear film according to the disclosure. In the method, a thermoplastic resin is coextruded, extrusion-coated and/or laminated, preferably coextruded into a thermoplastic carrier film, an adhesion promoter into an adhesion promoter layer, and a mixture comprising polymethyl methacrylate and polyorganosiloxane into an antiwear layer while forming the antiwear film.

Coextrusion in particular means that the thermoplastic resin is coextruded into the thermoplastic carrier film, the adhesion promoter into the adhesion promoter layer and the mixture comprising polymethyl methacrylate and polyorganosiloxane into the antiwear layer while forming the antiwear film. This means that the thermoplastic resin, the adhesion promoter and the mixture comprising polymethyl methacrylate and polyorganosiloxane are respectively extruded by an extruder and are directly brought together, whereby the antiwear film is directly obtained.

Advantageously, the antiwear film according to the disclosure can be produced particularly well by the method described above.

Extrusion coating in particular means that at least one of the thermoplastic carrier film, the adhesion promoter layer and the antiwear layer is/are extruded separately in a first step, and in a second and third step the remaining layers are extruded onto the layer extruded first.

In this embodiment, it may preferably be provided that the thermoplastic carrier film is produced in the first step, the adhesion promoter layer is extruded onto the thermoplastic carrier film in the second step, and the antiwear layer is extruded onto the adhesion promoter layer in the third step.

Laminating in particular means that the layers are all produced individually and are bonded together in a separate step.

It may be provided that processes are combined with each other. For example, it may be provided that the thermoplastic carrier film is produced in a first step and the adhesion promoter layer is extruded thereon in a second step. In a third step, for example, the antiwear layer can be extruded separately and then laminated onto the layer composite of thermoplastic carrier film and adhesion promoter layer. Alternatively, for example, the thermoplastic carrier film and the adhesion promoter layer can be coextruded. The antiwear layer can then be extruded separately and subsequently laminated onto the layer composite of thermoplastic carrier film and adhesion promoter layer.

It may preferably be provided that the thermoplastic resin, the adhesion promoter and the mixture of polymethyl methacrylate and polyorganosiloxane or polymethyl methacrylate and polyorganosiloxane are provided as a pourable solid, in particular, for example, as a granulate, and are fed into the corresponding extruder.

A “pourable” solid can be understood in particular as a solid which can be applied onto a subsurface by a pouring or spreading process. Furthermore, a “granulate” or a “granular material” can be understood to mean a solid or an aggregate material of a solid, which comprises or consists of a plurality of solid particles, such as grains or spheres. Byway of example but not by way of limitation, granular or powdery materials may be mentioned here.

The disclosure also proposes a method of producing a decorative panel according to the disclosure. The method comprises at least the method steps:
a) providing an antiwear film according to the disclosure,
b) providing a carrier plate,
c) applying a decorative layer onto the carrier plate and/or the thermoplastic carrier film of the antiwear film,
d) applying a laminating adhesive layer onto the carrier plate and/or the thermoplastic carrier film of the antiwear film,
e) bonding the antiwear film and the carrier plate to form the decorative panel.

By means of the method described above, the decorative panel according to the disclosure can be produced particularly well.

Bonding the antiwear film and the carrier plate is to be understood as bonding them via the layers applied in steps c) and d).

Providing the antiwear film according to the disclosure may preferably comprise the method for producing the antiwear film according to the disclosure.

In a preferred embodiment, it may be provided that the antiwear film is produced separately from the decorative panel.

Thus, it can be ensured during the production of the decorative panel that only a defect-free antiwear film is used for the production. Advantageously, this can reduce the number of rejects in the production of decorative panels, since if there is a defect in the antiwear film it is not necessary to discard the entire decorative panel.

In an alternative preferred embodiment, it may be provided that the antiwear film is provided bonded to the carrier plate. In other words, this means that the antiwear film is provided according to steps c) and d), wherein the antiwear film is produced while forming the decorative panel bonded to the carrier plate.

Advantageously, this allows the method to be carried out in a single process, wherein the process is preferably continuous.

For example, it may preferably be provided that the antiwear film is coextruded directly onto the applied laminating adhesive layer in accordance with the method of the disclosure. Alternatively, it may be provided that the thermoplastic carrier film is extruded or laminated onto the laminating adhesive layer and then the adhesion promoter layer and the antiwear layer are extruded or laminated onto the thermoplastic carrier film.

In a preferred embodiment, it may be provided that providing a carrier plate comprises the steps:
i) providing a pourable carrier material, in particular a granular material, wherein the carrier material may be configured as described in detail above,
ii) arranging the carrier material between two belt-like conveying means, iii) forming the carrier material under the influence of temperature while forming a web-shaped carrier,
iv) compressing the carrier,
v) treating the carrier under the influence of pressure by use of a two-belt press, vi) optionally cooling the carrier.

In a preferred embodiment, it may be provided that in step c) the decorative layer is applied onto the carrier plate and in method step d) the laminating adhesive layer is applied onto the decorative layer on the carrier plate. In other words, it may be provided that in step c) the decorative layer is applied onto the carrier plate and in process step d) the laminating adhesive layer is applied onto the carrier plate, which means that the laminating adhesive layer is applied onto the decorative layer that is already disposed on the carrier plate.

In this way, a decorative panel can be produced which comprises a decorative layer applied onto the carrier plate and will be bonded to the thermoplastic carrier film via the laminating adhesive layer

In an alternative preferred embodiment, it may be provided that in step c) the decorative layer is applied onto the thermoplastic carrier film of the antiwear film and in method step d) the laminating adhesive layer is applied onto the carrier plate.

In a further alternative preferred embodiment, it can be provided that in step c) the decorative layer is applied onto the thermoplastic carrier film of the antiwear film, and in method step d) the laminating adhesive layer is applied onto the decorative layer.

Further alternatively, it may be provided that in step c) a first decorative layer is applied onto the thermoplastic carrier film and a second decorative layer is applied onto the carrier plate, and in method step d) the laminating adhesive layer is applied onto the carrier plate or the thermoplastic carrier film.

Preferably, it may be provided that after step d) a lacquer-containing top layer is applied onto the antiwear layer, wherein the lacquer-containing top layer preferably comprises a topcoat selected from the group consisting of melamine resin and acrylate-based plastic compositions, in particular polyurethane-modified acrylate plastic compositions.

Preferably, it may be provided that the antiwear layer is at least partially provided with a surface structuring, preferably with a surface structuring at least partially synchronous with the decorative layer.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The disclosure is further explained below with reference to the figures. The figures show possible embodiments of the disclosure. In principle, however, combinations or variations of the design are possible within the scope of the disclosure.

FIG. 1 shows schematically the structure of an antiwear film according to the disclosure;

FIG. 2 shows schematically the structure of a first embodiment of a decorative panel according to the disclosure; and

FIG. 3 shows schematically the structure of a second embodiment of a decorative panel according to the disclosure.

### DETAILED DESCRIPTION

Example embodiments will now be described more fully with reference to the accompanying drawings.

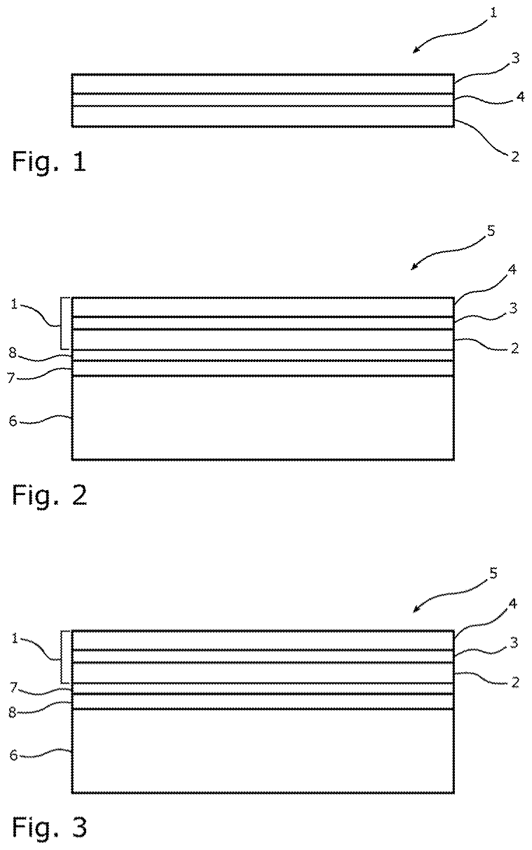

In detail, FIG. 1 schematically shows the cross section of an antiwear film 1 according to the disclosure. The antiwear film 1 comprises a thermoplastic carrier film 2 and an antiwear layer 3 disposed on the thermoplastic carrier film 2, wherein between the thermoplastic carrier film 2 and the antiwear layer 3 an adhesion promoter layer 4 is arranged at least in part. The antiwear film 1 is thus formed from a stack of at least the thermoplastic carrier film 2, the adhesion promoter layer 4 and the antiwear layer 3. The thermoplastic carrier film 2 comprises a thermoplastic resin, the adhesion promoter layer 4 comprises an adhesion promoter, and the antiwear layer 3 comprises a mixture comprising a polymethyl methacrylate and polyorganosiloxane.

The antiwear film 1 shown was produced according to the method according to the disclosure by coextruding the thermoplastic resin to the thermoplastic carrier film 2, the adhesion promoter to the adhesion promoter layer 4 and the mixture comprising polymethyl methacrylate and polyorganosiloxane to the antiwear layer 3 while forming the antiwear film 1.

In detail, FIGS. 2 and 3 schematically show the cross-section of two different embodiments of the decorative panel 5 according to the disclosure. The decorative panel 5 comprises a carrier plate 6, a decorative layer 7, a laminating adhesive layer 8 and an antiwear film 1. According to the disclosure, the antiwear film 1 comprises a thermoplastic carrier film 2 and an antiwear layer 3 arranged on the thermoplastic carrier film 2, wherein an adhesion promoter layer 4 is arranged at least partially between the thermoplastic carrier film 2 and the antiwear layer 3. The antiwear film 1 is aligned at the carrier film side, i.e. with the side at which the carrier film 2 is disposed, with respect to carrier plate 6, wherein the decorative layer 7 and the laminating adhesive layer 8 are disposed between the carrier plate 6 and the thermoplastic carrier film 2.

In the embodiment of the decorative panel 5 shown in FIG. 2 the decorative layer 7 is disposed directly on the carrier plate 6, and the laminating adhesive layer 8 is disposed between the decorative layer 7 and the thermoplastic carrier film 2. In the embodiment of the decorative panel 5 shown in FIG. 3, in contrast to FIG. 2, the laminating adhesive layer 8 is disposed directly on the carrier plate 6 and the decorative layer 7 is disposed between the thermoplastic carrier film 2 and the laminating adhesive layer 8.

The decorative panels shown were produced by the method according to the disclosure. For the embodiment shown in FIG. 2, the antiwear film 1 and the carrier plate 6 were provided. Subsequently, the decorative layer 7 was applied onto the carrier plate 6. Then the laminating adhesive layer 8 was applied onto the carrier plate 6. Since the carrier plate sheet 6 was already covered with the decorative layer 7, the laminating adhesive layer 7 does not contact the carrier plate 6 directly, but is disposed on the decorative layer 7 on the carrier plate 6. Subsequently, the antiwear film 1 and the carrier plate 6 provided with the decorative layer 7 and the laminating adhesive layer 8 were bonded together while forming the decorative panel 5 shown in FIG. 2.

For the embodiment shown in FIG. 3, the antiwear film 1 and the carrier plate were provided. Subsequently the decorative layer 7 was applied onto the thermoplastic carrier plate 2 of the antiwear film 1. In a subsequent or parallel step, the laminating adhesive layer 8 was applied onto the carrier plate 6. Subsequently, the antiwear film 1 provided with the decorative layer 7 at the carrier film side and the carrier plate 6 provided with the laminating adhesive layer 8 were bonded to each other while forming the decorative panel 5 shown in FIG. 3.

The foregoing description of the embodiments has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. An antiwear film, wherein the antiwear film comprises a thermoplastic carrier film and an antiwear layer disposed on the thermoplastic carrier film, wherein an adhesion promoter layer is disposed at least partially between the thermoplastic carrier film and the antiwear layer, wherein
the thermoplastic carrier film comprises a thermoplastic resin, the adhesion promoter layer comprises an adhesion promoter, and
the antiwear layer comprises a mixture comprising a polymethyl methacrylate and polyorganosiloxane.

2. The antiwear film according to claim 1, wherein the thermoplastic resin is selected from the group consisting of polypropylene, polyvinyl chloride, polyethylene, copolymers thereof and mixtures thereof, wherein the thermoplastic resin is in particular polypropylene.

3. The antiwear film according to claim 1, wherein the adhesion promoter is a polyolefin copolymer, preferably a polyolefin graft copolymer, particularly preferably a polypropylene graft copolymer, in particular a maleic anhydride-modified polypropylene graft copolymer.

4. The antiwear film according to claim 3, wherein the maleic anhydride-modified polypropylene graft copolymer has a maleic acid content in a range from greater than or equal to 0.1 wt.-% to less than or equal to 5 wt.-%, preferably from greater than or equal to 0.5 wt.-% to less than or equal to 1.5 wt.-%, based on the maleic anhydride-modified polypropylene graft copolymer.

5. The antiwear film according to claim 1, wherein the polymethyl methacrylate comprises an impact strength modifier, in particular in an amount in a range from greater than or equal to 0.1 wt.-% to less than or equal to 5 wt.-%, preferably from greater than or equal to 0.5 wt.-% to less than or equal to 5 wt.-%, based on the polymethyl methacrylate.

6. The antiwear film according to claim 1, wherein the polyorganosiloxane is a polydimethylsiloxane.

7. The antiwear film according to claim 1, wherein the polyorganosiloxane has a number average molecular weight in a range from greater than or equal to 50 kDa to less than or equal to 700 kDa, preferably from greater than or equal to 100 kDa to less than or equal to 500 kDa, further preferably greater than or equal to 150 kDa to less than or equal to 300 kDa.

8. The antiwear film according to claim 1, wherein the mixture comprising polymethyl methacrylate and polyorganosiloxane comprises polymethyl methacrylate in a range from greater than or equal to 90 wt.-% to less than 100 wt.-%, preferably greater than or equal to 95 wt.-% to less than or equal to 99.9 wt.-%, more preferably greater than or equal to 98 wt.-% to less than or equal to 99.5 wt.-%, particularly preferably greater than or equal to 98.5 wt.-% to less than or equal to 99 wt.-%, based on the mixture,
wherein the mixture comprising polymethyl methacrylate and polyorganosiloxane comprises polyorganosiloxane in a range of greater than 0 wt.-% to less than or equal to 10 wt.-%, preferably greater than or equal to 0.1 wt.-% to less than or equal to 5 wt.-%, more preferably greater than or equal to 0.5 wt.-% to less than or equal to 2 wt.-%, particularly preferably greater than or equal to 1 wt.-% to less than or equal to 1.5 wt.-%, based on the mixture.

9. A decorative panel, wherein the decorative panel comprises a carrier plate, at least one decorative layer and an antiwear film according claim 1, wherein the antiwear film is aligned at the carrier film side with respect to the carrier plate, and the decorative layer and the laminating adhesive layer are disposed between the carrier plate and the thermoplastic carrier film.

10. The decorative panel according to claim 9, wherein at least one laminating adhesive layer is disposed between the decorative layer and the antiwear film.

11. The decorative panel according to claim 9, wherein the decorative layer is disposed on the carrier plate and/or the thermoplastic carrier film.

12. The decorative panel according to claim 10, wherein the laminating adhesive layer comprises a laminating adhesive selected from the group consisting of hotmelt adhesive and UV-curable adhesive.

13. The decorative panel according to claim 9, wherein the carrier plate comprises polypropylene, polyethylene, polyvinyl chloride, copolymers thereof and mixtures thereof.

14. A method for producing an antiwear film according to claim 1, wherein a thermoplastic resin is coextruded, extrusion-coated and/or laminated, preferably coextruded to a thermoplastic carrier film, an adhesion promoter to an adhesion promoter layer and a mixture comprising polymethyl methacrylate and polyorganosiloxane to an antiwear layer while forming the antiwear film.

15. A method for producing a decorative panel according to claim 9, comprising:
a) providing an antiwear film according to claim 1;
b) providing a carrier plate;
c) applying a decorative layer onto the carrier plate and/or the thermoplastic carrier film of the antiwear film;
d) optionally applying a laminating adhesive layer onto the carrier plate and/or the thermoplastic carrier film of the antiwear film; and
e) bonding the antiwear film and the carrier plate while forming the decorative panel.
